(19) United States
(12) Patent Application Publication
(10) Pub. No.: US 2025/0077419 A1
(43) Pub. Date: Mar. 6, 2025

(54) SYSTEMS AND METHODS OF CONTROLLING WRITE AMPLIFICATION FACTOR IN STORAGE DEVICES

(71) Applicant: Samsung Electronics Co., Ltd., Suwon-si (KR)

(72) Inventors: Daniel Lee HELMICK, Erie, CO (US); Daniel John BENJAMIN, Savage, MN (US); Michael ALLISON, Prospect, CO (US)

(21) Appl. No.: 18/817,185

(22) Filed: Aug. 27, 2024

Related U.S. Application Data
(60) Provisional application No. 63/535,051, filed on Aug. 28, 2023.

(51) Int. Cl. G06F 12/02

(52) U.S. Cl. CPC G06F 12/0246

(57) ABSTRACT

Provided are systems, methods, and apparatuses for controlling write amplification factor in storage devices. The systems, devices, and methods include obtaining access to a storage device with a physical storage capacity, a logical storage capacity being mapped to the physical storage capacity, and an overprovisioning capacity being based on a ratio of the physical storage capacity. The systems, devices, and methods include assigning a first portion of the logical storage capacity to a first reclaim unit handle and a second portion of the logical storage capacity to a second reclaim unit handle, selecting the second reclaim unit handle to manage random write operations based on identifying the random write operations on the storage device, reducing, based on the selecting, the second portion of the logical storage capacity, and assigning, based on the selecting, an amount of the overprovisioning capacity to the second reclaim unit handle.

### CROSS-REFERENCE TO RELATED APPLICATIONS

This application claims the benefit of U.S. Provisional Patent Application Ser. No. 63/535,051, filed Aug. 28, 2023, which is incorporated by reference herein for all purposes.

### TECHNICAL FIELD

The disclosure relates generally to memory systems, and more particularly to controlling write amplification factor in storage devices.

### BACKGROUND

The present background section is intended to provide context only, and the disclosure of any concept in this section does not constitute an admission that said concept is prior art.

Write amplification occurs when a NAND flash-based storage drive writes more data to the storage medium than the host submits. A high write amplification factor (WAF) can negatively affect storage performance and durability of the storage drive. WAF can be a numerical value that measures how much more data a solid-state drive (SSD) controller writes than the host's flash controller. WAF is calculated by dividing the total bytes written to the NAND flash memory by the total bytes written by the host. A WAF of 1 may indicate no write amplification, while a WAF value greater than 1 can indicate some level of write amplification.

### SUMMARY

In various embodiments, the systems and methods described herein include systems, methods, and apparatuses for controlling write amplification factor in storage devices. In some aspects, the systems and methods described herein relate to a method of storage management by a host, the method including: obtaining access to a storage device with a physical storage capacity, a logical storage capacity mapped to the physical storage capacity, and an overprovisioning capacity based on a ratio of the physical storage capacity; assigning a first portion of the logical storage capacity to a first reclaim unit handle and a second portion of the logical storage capacity to a second reclaim unit handle; selecting the second reclaim unit handle to manage random write operations based on identifying the random write operations on the storage device; reducing, based on the selecting, the second portion of the logical storage capacity; and assigning, based on the selecting, an amount of the overprovisioning capacity to the second reclaim unit handle.

In some aspects, the techniques described herein relate to a method, further including: assigning a first set units to the first reclaim unit handle, and assigning a second set units to the second reclaim unit handle.

In some aspects, the techniques described herein relate to a method, further including: adding a reclaim unit to the first set units based on determining the first set units satisfy a fill threshold; and assigning a first portion unit handle based on adding the reclaim unit to the first set units.

In some aspects, the techniques described herein relate to a method, wherein a reclaim unit units or the second set units includes a group of erase blocks of the storage device.

In some aspects, the techniques described herein relate to a method, further including: determining the first reclaim unit handle writes data sequentially; and verifying, based on the determining, that write commands associated with a first reclaim unit units are completed prior to initiating a write command to a second reclaim unit units.

In some aspects, the techniques described herein relate to a method, further including configuring a queue depth of the host to be equal to one.

In some aspects, the techniques described herein relate to a method, wherein the amount of the overprovisioning capacity is greater than the second portion of the logical storage capacity, the amount of the overprovisioning capacity including at least a majority of the overprovisioning capacity.

In some aspects, the techniques described herein relate to a method, wherein data associated with at least one unit handle or the second reclaim unit handle is written in a circular first in first out configuration.

In some aspects, the techniques described herein relate to a method, wherein selecting the second reclaim unit handle to manage the random write operations includes routing the random write operations to the second reclaim unit handle.

In some aspects, the techniques described herein relate to a method, wherein the storage device includes a solid-state drive configured for flexible data placement based on a non-volatile memory express protocol.

In some aspects, the techniques described herein relate to a device including: one or more processors; and memory storing instructions that, when executed by the one or more processors, cause the device to: obtain access to a storage device with a physical storage capacity, a logical storage capacity mapped to the physical storage capacity, and an overprovisioning capacity based on a ratio of the physical storage capacity; assign a first portion of the logical storage capacity to a first reclaim unit handle and a second portion of the logical storage capacity to a second reclaim unit handle; select the second reclaim unit handle to manage random write operations based on identifying the random write operations on the storage device; reduce, based on the selecting, the second portion of the logical storage capacity; and assign, based on the selecting, an amount of the overprovisioning capacity to the second reclaim unit handle.

In some aspects, the techniques described herein relate to a device, wherein the instructions, when executed by the one or more processors, further cause the device to: assign a first set units to the first reclaim unit handle, and assign a second set units to the second reclaim unit handle.

In some aspects, the techniques described herein relate to a device, wherein the instructions, when executed by the one or more processors, further cause the device to: add a reclaim unit to the first set units based on determining the first set units satisfy a fill threshold; and assign a first portion unit handle based on adding the reclaim unit to the first set units.

In some aspects, the techniques described herein relate to a device, wherein a reclaim unit units or the second set units includes a group of erase blocks of the storage device.

In some aspects, the techniques described herein relate to a device, wherein the instructions, when executed by the one or more processors, further cause the device to: determine the first reclaim unit handle writes data sequentially; and verify, based on the determining, that write commands associated with a first reclaim unit units are completed prior to initiating a write command to a second reclaim unit units.

In some aspects, the techniques described herein relate to a device, wherein the instructions, when executed by the one or more processors, further cause the device to configure a queue depth of the device to be equal to one.

In some aspects, the techniques described herein relate to a device, wherein the amount of the overprovisioning capacity is greater than the second portion of the logical storage capacity, the amount of the overprovisioning capacity including at least a majority of the overprovisioning capacity.

In some aspects, the techniques described herein relate to a non-transitory computer-readable medium storing code that includes instructions executable by a processor to: obtain access to a storage device with a physical storage capacity, a logical storage capacity mapped to the physical storage capacity, and an overprovisioning capacity based on a ratio of the physical storage capacity; assign a first portion of the logical storage capacity to a first reclaim unit handle and a second portion of the logical storage capacity to a second reclaim unit handle; select the second reclaim unit handle to manage random write operations based on identifying the random write operations on the storage device; reduce, based on the selecting, the second portion of the logical storage capacity; and assign, based on the selecting, an amount of the overprovisioning capacity to the second reclaim unit handle.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods of controlling write amplification factor in storage devices described herein include multiple advantages and benefits. For example, the systems and methods minimize write amplification factor (WAF) based on a host controlling aspects of a flexible data placement storage device. Also, by controlling aspects of flexible data placement storage devices, a host triggers garbage collection (GC) less frequently (e.g., avoids triggering GC), which results in improved system performance.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example format in accordance with one or more implementations as described herein.

FIG. 5 illustrates an example system in accordance with one or more implementations as described herein.

FIG. 6A and FIG. 6B illustrate aspects of example data structures in accordance with one or more implementations as described herein.

FIG. 7 illustrates an example circular buffer in accordance with one or more implementations as described herein.

FIG. 8 illustrates an example storage configuration in accordance with one or more implementations as described herein.

FIG. 9 depicts a flow diagram illustrating an example method associated with the disclosed systems, in accordance with example implementations described herein.

FIG. 10 depicts a flow diagram illustrating an example method associated with the disclosed systems, in accordance with example implementations described herein.

FIG. 11A and FIG. 11B illustrate aspects of example data structures in accordance with one or more implementations as described herein.

FIG. 12 illustrates an example graph in accordance with one or more implementations as described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with an example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

In some examples, solid-state drives (SSDs) are storage devices used in computers that store data on solid-state flash memory (e.g., NAND flash memory). NAND flash is a non-volatile storage technology that stores data without requiring power. NAND flash may be referred to as a memory chip. Flash memory cards and SSDs use multiple NAND flash memory chips to store data. In data management, “hot” data is data that is frequently accessed and/or in high demand, while “cold” data includes data that is infrequently accessed and/or infrequently in demand (e.g., set and forget data).

SSDs can work with a computer's memory (random-access memory (RAM)) and processor to access and use data. This includes files like operating systems, programs, documents, games, images, media, etc. SSDs are permanent or non-volatile storage devices, meaning SSDs maintain stored data even when power to the computer is off. SSDs may be used as secondary storage in a computer's storage hierarchy.

In some cases, storage drives (e.g., SSDs) may include a queue length, queue size, or queue depth (QD). QD is the number of input/output (I/O) requests that a storage device can handle at any given time. In some cases, QD may refer to the number of IO operations a host can queue for a storage device.

In storage devices (e.g., SSD), a page can be the smallest unit, while a block can be the smallest unit of erase access. A page may be 4 kilobytes (KB) in size. Pages can be made up of several memory cells and are the smallest unit of a storage device. Several pages on the storage device may be summarized to a block. A block is the smallest unit of access on an storage device (e.g., reading, writing, erasing, etc.). In some examples, 128 pages may be combined into one block, where a block includes 512 KB. A block may be referred to as an erase unit. The size of a block or erase unit determines the garbage collection (GC) granularity of the storage device (e.g., at the SSD software level). The logical block address (LBA) is the standard used to specify the address for read and write commands on a storage device. Some storage devices may report their LBA size as 512 bytes or 4 KB, though they may use larger blocks physically. These blocks can be 4 KB, 8 KB, or sometimes larger. In some cases, a storage device may include a map unit (e.g., 4 KB map unit), which may represent a read size. Some storage devices may include a Word Line (e.g., 16 KB Word Line (WL)), which can represent another read size (e.g., of relatively large commands). In some cases, multiple WLs combined may represent a Page of a storage device (e.g., 3 WLs for TLC drives giving 48 KB pages; 4 WLs for QLC drives giving 64 KB pages). In some cases, Pages can be a Program size. An Erase Block (EB) may be filled one page at a time. In some cases, many small writes may be aggregated to fill a page prior to programming the page. An EB can include many pages, which can represent the Erase Size.

Unlike a hard disk drive (HDD), SSDs and other NAND flash storage do not overwrite existing data. Instead, SSDs can go through a program/erase cycle. SSD garbage collection (GC) is an automated process that improves the write performance of SSDs. The goal of garbage collection is to periodically optimize the drive so that it runs efficiently and maintains performance throughout its life. With SSD garbage collection, the SSD (e.g., a storage controller or storage processing unit of the SSD) searches for pages that have been marked as stale (e.g., data that is out-of-date, obsolete, or no longer accurate). The SSD copies data still in use to a new block and then deletes all data from the old one. The SSD marks the old data as invalid and writes the new data to a new physical location.

Peripheral component interconnect express (PCIe) can include an interface that connects high-speed data between electronic components in a computer system. PCIe can be used for connecting expansion cards to the motherboard, such as graphics cards, network cards, storage devices (e.g., SSDs), storage controllers, memory devices, memory controllers, processors, and the like. In some examples, PCIe slots can connect a computer motherboard to peripheral components (e.g., PCIe ×1, PCIe ×4, PCIe ×8, PCIe ×16). PCIe can be forwards and/or backwards compatible. For example, a PCIe 3.0 card can be put in a PCIe 4.0 slot, but the PCIe 3.0 card may be restricted to lower speeds of PCIe 3.0.

In some examples, non-volatile memory express (NVMe) is a data transfer protocol that may be configured to connect SSD storage to servers and/or processors using the PCIe bus. NVMe was created to improve speed and performance of computer systems. An NVMe controller can include a logical-device interface specification that allows access to a computer's non-volatile storage media. NVMe controllers are optimized for high-performance random read/write operations. In some cases, the NVMe controller can perform flash management operations of an SSD on-chip, while consuming negligible host processing and memory resources. NVMe can perform parallel input/output (I/O) operations with multicore processors to facilitate high throughput. NVMe controllers can map I/O and responses to shared memory in a host computer over a PCIe interface. In some cases, NVMe controllers can communicate directly with a host central processing unit (CPU).

In some examples, a virtual machine (VM) can be the virtualization or emulation of a computer system. Virtual machines can be based on computer architectures and provide the functionality of a physical computer. Their implementations may involve specialized hardware, software, or a combination of the two. In some cases, virtual machines can differ and can be organized by their function. A VM can include a software-based computer that acts like a physical computer. VMs can be referred to as guest machines. VMs can be created by borrowing resources from a physical host computer or a remote server. One or more virtual “guest” machines run on a physical “host” machine.

In some examples, PCIe may use functions to enable separate access to its resources. These functions can include physical functions (e.g., PCIe physical function) and/or virtual functions (e.g., PCIe virtual function). In some cases, a PCIe device may be split into multiple physical functions. In some examples, the single root I/O virtualization (SR-IOV) interface is an extension to PCIe. SR-IOV can configure a physical device to appear as multiple separate physical devices (e.g., to a hypervisor, to a guest operating system, etc.). In some cases, SR-IOV allows a device (e.g., a network adapter) to separate access to its resources among various PCIe hardware functions. These functions can include physical functions (e.g., PCIe physical function) and/or virtual functions (e.g., PCIe virtual function). In some examples, SR-IOV may enable one PFO and one or more VFs (e.g., where the VFs and PFs serve a similar function). In some cases, restructuring may provide various mixtures of PF and VF combinations.

Write amplification factor (WAF) can be based on a phenomenon that occurs when the amount of data written to storage media is more than the intended amount. This can happen in flash memory and solid-state drives (SSDs). WAF occurs when a host computer writes a different amount of logical data than the amount of physical data written. In other words, WAF occurs when the actual amount of written physical data differs from the amount of logical data that is written by the host computer. WAF can be caused by a disconnect between the device and the host. The host may not have enough information to understand the device's physical layout or know about data that is often used together. WAF can negatively affect the performance and durability of storage and can also shorten the life cycle of a device.

In some examples, WAF is a multiplier applied to data during write operations. WAF is the factor by which written data is amplified. WAF is calculated by dividing the amount of data written to flash media by the amount of data written by the host. An ideal SSD has a WAF of 1.0 (e.g., WAF=1). A WAF of 1 indicates there is no write amplification. SSDs may use garbage collection to reclaim unused space, which can also lead to write amplification.

Some approaches to SSD data placement can result in write amplification that may be caused by storing different types of data (e.g., hot data, cold data) in the same NAND block (e.g., same erase unit). For example, at time to, Block A includes pages a, b, c, d, and c:
Block A at time to: [(a)(b)(c)(d)(c)]; a/c=hot data; b/d/e=cold data.

Pages a and c contain hot data, while pages b, d, and e contain cold data. As a result, the “hot” data of pages a and c is likely to be updated, while the “cold” data of pages b, d, and e is likely to remain unchanged for a given time period.

At time t1, Block A is selected as a garbage collection (GC) candidate. For example, at time t1, the version of pages a and c in Block A are out of date and the data in pages a and c are invalidated due to an update (e.g., an update to pages a and c):
Block A at time t1: [(a*)(b)(c*)(d)(c)]; a/c=*invalidated; b/d/e=cold data;

Accordingly, Block A is selected as a GC candidate based on pages a and c in Block A being out-of-date data (e.g., invalid or stale data). Because a block of flash memory is not capable of doing in-place update (e.g., updating page a and page c in Block A), at time t2 (e.g., some time after time t1) the updated data for pages a and c is written to another block (e.g., Block C):
Block C at time t2: [(a)(c)( )( )( )]; new version of a/c.

However, pages b, d and e of Block A are still valid (e.g., fresh data). Thus, at time t2 (e.g., some time after time t1, before or after a and c are written to Block C) pages b, d and e are written to a new block before Block A can be erased (e.g., written to Block B, resulting in write amplification):
Block A at time t2: [(a*)(b)(c*)(d)(c)]; a/c=*invalidated; b/d/e remain in Block A;
Block B at time t2: [(b)(d)(e)( )( )]; b/d/e copied to Block B.

Accordingly, the data movement from Block A to Block B causes write amplification since pages b, d and e are now written twice in two separate blocks of NAND.

Flexible data placement (FDP) is a feature of the NVMe specification that aims to improve performance by reducing write amplification. FDP provides a data placement mechanism called a Reclaim Unit (RU), which allows a host to control which logical blocks are written into a set of NAND blocks managed by an SSD. In addition, the host is able to write to more than one RU at a time allowing the host to isolate the data written to RU per application or even within an application to separate data written that has different life cycles (e.g., hot data, cold data).

Storage devices (e.g., based on FDP) may be configured to reduce WAF when multiple applications are writing, modifying and reading data on the same device. Such storage drives can give a host server more control over where data resides within an SSD. In some cases, such storage drives may does this by enabling the host to provide hints to the device when write requests occur. For example, the host might provide hints in write commands to indicate where to place the data via Placement Identifier (PID) or Reclaim Unit Handle (RUH).

An endurance group can include a group of one or more reclaim groups. In some examples, an endurance group can include a separate pool of storage for wear leveling purposes. Each endurance group can have its own dedicated pool of spare blocks and the drive reports separate wear statistics for each endurance group. In some examples, NVMe Endurance Group Management allows media to be configured into Endurance Groups and NVM sets. Endurance groups can enable granularity of access to the SSD.

A Reclaim Unit (RU) can include a set of NAND blocks to which a host may write logical blocks. In some cases, an RU includes a group of erase blocks of an SSD. An erase block can be a unit of NAND flash media that can be electrically erased using SSD internal functions. The size of an erase block can vary depending on the implementation (e.g., range from 512 KB to 128 MB). Erase blocks may be the smallest erasable unit of a NAND flash device or SSD. Each erase block may include multiple pages (e.g., 16 KB pages). The storage controller in a NAND flash SSD may write or read data at the page level, but may erase data at the block level. In some cases, several erase blocks (EBs) may get grouped together to form an RU. In some cases, the EBs that back an RU can be changed at any time. A Reclaim Group (RG) can include a set of RUs. In some cases, an RU may be considered a superblock (SB) where the host is provided the size of the RU and the host can manage which logical blocks are written to the RU, which is a capability that may not be available in non-FDP SSDs.

Data written to an RU may be written sequentially in the order received by the drive regardless of the LBA number associated with the data written to the RU. For example, data may be written sequentially to a first erase block of an RU, written sequentially to a second erase block of the RU when the first erase block is filled, and so on. In some cases, this RU may be erased sequentially, erasing the first erase block of the RU, then erasing the second erase block, and so on. Using sequential writes, data may be written starting at the start of a range of memory (e.g., at the start of an RU) and proceed writing sequentially until the RU is filled. Sequential writes can result in continuous streams of data with the LBA number incrementing with each command sent to the SSD. Therefore, sequential writes may follow an LBA order while writing in NAND memory. Sequential writes may wait until all of a first chunk of data to the storage device has been written before moving on to writing a second chunk of data.

Random writes to a storage device may not follow any order. Random writes in storage drives may include data being written to different locations across the drive's Namespace and/or LBA range (e.g., any LBA order and/or any Namespace) without following any order. Random writes can create a scattered data pattern with no clear starting point. Unlike sequential writing, random writes may jump back and forth across the storage device (e.g., across a given RU), creating a scattered data pattern with no clear starting point. Random writes can result in fragmented data in the storage device (e.g., in the RU).

When an RU is filled with data, a new set of empty erase blocks may be selected to create an additional RU. A new RU may be assigned to an RUH, and any new data directed to the RUH may be routed to the newly assigned RU. In some cases, a host may instruct the SSD where to store data by using the RUH. By implementing multiple RUHs, different applications may route data into different RUs (e.g., a first application to at least a first RUH, a second application to at least a second RUH different from the first RUH, etc.). A full RU of a given RUH may be replaced by an empty RU ready to receive more data for that RUH. For example, data from an application may be written to an application-specific area of the SSD (e.g., a specific RUH) to separate it from data associated with other applications because the other applications may be using one or more different RUHs. Without FDP, data from different applications may be written into a shared set of blocks rather than written into separate RUs. An RU can correspond to a physical memory unit and/or a logical memory unit. The SSD may be allowed to select which RU is being filled at any time, and the SSD may select which physical NAND composes each RU. It is noted that the systems and methods described herein may be performed by several types of storage devices. Reference to SSDs may be used throughout the description as one example of a storage device in which the systems and methods may be implemented.

A reclaim unit handle (RUH) can be a resource in an SSD that manages and buffers logical blocks to write to an RU. An RUH can be an identifier that may be configured to behave similar to a pointer. An RUH may indicate an RU that is getting filled on the NAND storage. In some cases, some storage drives (e.g., enterprise SSDs) may be configured to power protect data in flight. As a result, additional resources (e.g., buffers) can be identified by or associated with an RUH. For example, an RUH may be configured to receive a write command, parse the command, and pull in the data into a buffer that is associated with the RUH. The commands to a given RUH may be completed while the buffered data progresses through other stages (e.g., appended to other data that is also getting stored on the NAND, adding Protection Information, Error Correction Code (ECC), encryption, etc.) in the controller until the data is programmed in the NAND.

A namespace can be allowed access to one or more RUHs. If a namespace has access to more than one RUH, the host may be allowed to write to multiple RUs at the same time. Each RUH may identify a different RU for writing the user's data, and a new unique RU may be selected after filling the current RU. A reclaim group (RG) can be a group of two or more RUs. In some cases, a namespace can access one or more RUHs. In some implementations, a Placement Identifier may be used to indirectly identify an RUH. A namespace can be a collection of logical block addresses (LBAs) that are accessible to host software. In some cases, namespaces divide a storage device (e.g., an NVMe SSD) into logically separate and individually addressable storage spaces where each namespace can have its own I/O queue.

It is noted that a drive is free to select which RUs are used by the RUH at any time. In some cases, the RUH may be treated as a pointer to a particular RU at any given time. An RUH may point to one RU within an RG. Within an RG, an RUH may have one RU it is pointing to and filling at a given time. The RU can change and be selected by the drive anytime the RU fills and a new RU selection is used. In some cases, an RG may be considered a physical boundary. For example, a die may be one RG, there may be one RG per die, there may be one RG for all the die on a channel, etc. RUs can be the same size. An RUH can be a pointer. The pointer can identify one RU inside of each RG. An RG/RUH pair can individually identify one RU that is presently getting filled with data. Thus, there can be one RG per tenant, one RUH per tenant, and/or one RG/RUH pair per tenant. In some cases, RU per tenant may not be configurable since RUs may not be addressable by the host.

A zoned namespace (ZNS) can separate the logical address space into fixed-sized zones. ZNS devices can divide functionality between the device controller and host software. Streams may include or be associated with a descriptor called Streams Granularity Size (SGS). SGS can be used in a manner similar to how RU size may be used. In some examples, stream number and RUH ID may be used interchangeably.

To obtain a WAF of 1, the host may overwrite or deallocate all of the logical blocks written to an RU before the a storage device erases the NAND blocks in the RU for future writes. If the host is rewriting logical blocks prior to garbage collection on the previous written data for those logical blocks, then by the time the storage device performs garbage collection, all of the previously written data may be considered invalid and the storage device does not have to move the logical blocks (e.g., no host action required). Otherwise, the host may track each logical block written to each RG. For those logical blocks that have not been rewritten or deallocated, the host may copy those logical blocks to another RU to avoid garbage collection by the storage device. In this case, the WAF is 1 for that RU, but the system may incur an increase in WAF as the host may be constrained to move the logical blocks instead of the storage device as part of garbage collection.

In some embodiments, one or more elements may be indicated with initials, acronyms, abbreviations, and/or the like as follows: flexible data placement (FDP), reclaim unit (RU), reclaim unit handle (RUH), write amplification factor (WAF), over-provisioning (OP), queue depth (QD), garbage collection (GC), file system (FS), first-in, first-out (FIFO), solid state drive (SSD), rand (random), logical block address (LBA), read (rd or RD), write (wr or WR), not-AND (NAND) (e.g., NAND flash), software (SW), virtual machine (VM), virtual machine manager (VMM), zoned namespaces (ZNS), File System (FS), application (app), and/or flash translation layer (FTL).

For purposes of illustration, some embodiments may be described in the context of specific implementation details such as NAND flash nonvolatile memory and/or storage, SSDs, and/or the like. However, the embodiments are not limited to these or any other details and may be implemented with any other details including volatile and/or nonvolatile memory, structures, operations, storage devices, and/or the like.

One or more aspects of an FDP scheme in accordance with example embodiments of the disclosure may enable a host workload to reduce a WAF. Depending on the implementation details, some embodiments may achieve a WAF equal to 1 (e.g., WAF==1). In some embodiments, WAF==1 may refer to a WAF that may be equal, or nearly equal, to one, for example, to an extent that may considered to be essentially equal to one.

Some devices may implement a Flexible Data Placement (FDP) scheme in which an application may direct write data to be co-located in a storage media (e.g., in an SSD). In some embodiments, a VMM may configure defaults for one or more VMs. In some embodiments of an FDP scheme, and depending on the implementation details, filling and/or deallocating operations may achieve a relatively low WAF (e.g., WAF==1).

Table 1 provides some example comparative aspects of storage features such streams, FDP, and/or ZNS.

TABLE 1

| | Flexible Data | Zoned Namespaces |
|---|---|---|
| Streams | Placement (FDP) | (ZNS) |
| Open Loop WAF == 1 | Polling for WAF == 1 | WAF == 1 or Error |
| Backwards Compatible | Backwards Compatible | May involve revisions |
| Streams Granularity | Reclaim Unit (RU) | Zone Capacity <= |
| Size (SGS) | Size | Zone Size |
| Placement and LBA | Placement and LBA | Placement and LBA |
| disconnect | disconnect | relationship |
| QD > 1 allowed | QD > 1 allowed | QD > 1 may involve |
| | | Zone Append |
| FTL mapping (e.g., | FTL mapping (e.g., | Potential for compacted |
| full FTL mapping) | full FTL mapping) | FTL Mapping |
| may be involved | may be involved | |

In some embodiments, and depending on the implementation details, various WAF==1 workloads may be possible, for example, with workloads such as a circular FIFO, a modified Circular Buffer, and/or log structured file systems. In some embodiments, write, overwrite, and/or deallocate assurances may enable methods of reaching WAF==1. Some embodiments, e.g., for generalized use, may enable system OP (e.g., host OP and/or SSD OP) and/or design for relatively large host extents.

Any of the storage devices disclosed herein may be implemented using any type of storage media that may be used with FDP, for example, including any other type of solid state media, magnetic media (e.g., shingled magnetic recording (SMR)), optical media, and/or the like. For example, in some embodiments, a storage device may be implemented with a hard disk drive (HDD), a solid state drive (SSD) based, for example, on not-AND (NAND) flash memory, persistent memory such as cross-gridded nonvolatile memory, memory with bulk resistance change, phase change memory (PCM) and/or the like, and/or any combination thereof.

Any of the storage devices disclosed herein may be implemented in any form factor such as 3.5 inch, 2.5 inch, 1.8 inch, M.2, Enterprise and Data Center SSD Form Factor (EDSFF), NF1, and/or the like, using any connector configuration such as Serial ATA (SATA), Small Computer System Interface (SCSI), Serial Attached SCSI (SAS), U.2, and/or the like.

Any of the devices disclosed herein may be implemented entirely or partially with, and/or used in connection with, a server chassis, server rack, data room, datacenter, edge datacenter, mobile edge datacenter, and/or any combinations thereof.

Any of the functionality disclosed herein may be implemented with hardware, software, or a combination thereof including combinational logic, sequential logic, one or more timers, counters, registers, and/or state machines, one or more complex programmable logic devices (CPLDs), field programmable gate arrays (FPGAs), application specific integrated circuits (ASICs), central processing units (CPUs) such as complex instruction set computer (CISC) processors such as x86 processors and/or reduced instruction set computer (RISC) processors such as ARM processors, graphics processing units (GPUs), neural processing units (NPUs), tensor processing units (TPUs) and/or the like, executing instructions stored in any type of memory, or any combination thereof. In some embodiments, one or more components may be implemented as a system-on-chip (SOC).

In the embodiments described herein, the operations are example operations, and may involve various additional operations not explicitly illustrated. In some embodiments, some of the illustrated operations may be omitted. In some embodiments, one or more of the operations may be performed by components other than those illustrated herein. Additionally, in some embodiments, the temporal order of the operations may be varied. Moreover, the figures are not necessarily drawn to scale.

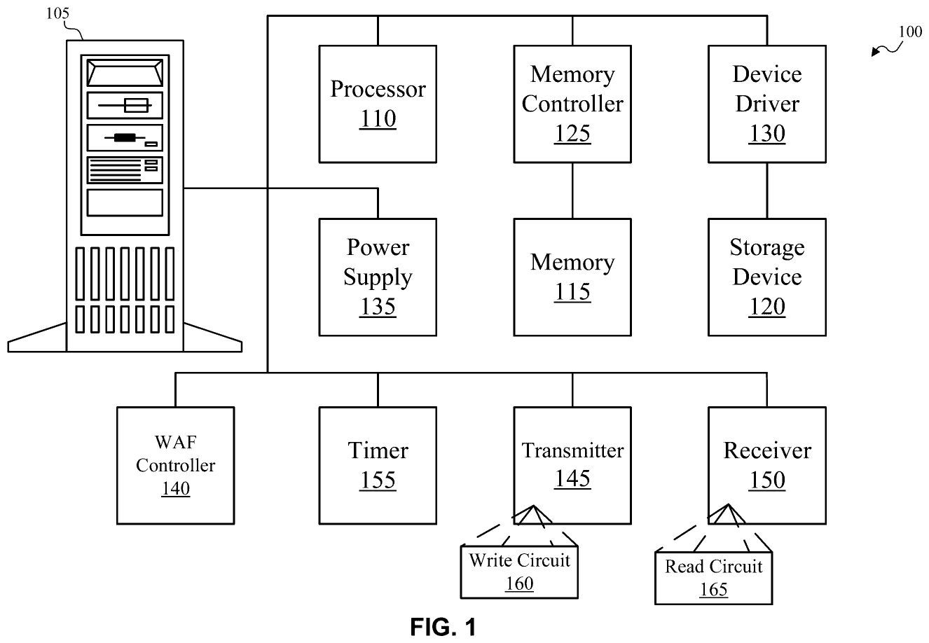

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for case of illustration: embodiments of the disclosure may include these components within the machine. While FIG. 1 shows a single processor 110, machine 105 may include any number of processors, each of which may be single core or multi-core processors, each of which may implement a RISC architecture or a Complex Instruction Set Computer (CISC) architecture (among other possibilities), and may be mixed in any desired combination.

Processor 110 may be coupled to memory 115. Memory 115 may be any variety of memory, such as flash memory, DRAM, Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI)(SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF)(including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115.

Machine 105 may include power supply 135. Power supply 135 may provide power to machine 105 and its components. Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120. In the illustrated example, machine 105 may include timer 155. Timer 155 may be configured to time one or more operations associated with the systems and methods described herein.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, write amplification factor (WAF) controller 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or SRAM, nonvolatile memory including flash memory, persistent memory such as cross-gridded nonvolatile memory, memory with bulk resistance change, phase change memory (PCM), and/or the like and/or any combination thereof, CPLDs, FPGAs, ASICs, CPUs including CISC processors such as x86 processors and/or RISC processors such as RISC-V and/or ARM processors), GPUs, NPUs, TPUs, OPUs, and/or the like, executing instructions stored in any type of memory. In some embodiments, one or more components of WAF controller 140 may be implemented as an SoC.

In some examples, WAF controller 140 may include any one or combination of logic (e.g., logical circuit), hardware (e.g., processing unit, memory, storage), software, firmware, and the like. In some cases, WAF controller 140 may perform one or more functions in conjunction with processor 110. In some cases, at least a portion of WAF controller 140 may be implemented in or by processor 110 and/or memory 115. The one or more logic circuits of WAF controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable WAF controller 140 to provide controlling write amplification factor in storage devices.

In one or more examples, WAF controller 140 may control write amplification factor in flexible data placement storage devices. In some cases, WAF controller 140 may minimize write amplification factor (WAF) based on a host being configured to control aspects of flexible data placement storage devices. Based on WAF controller 140 controlling aspects of flexible data placement storage devices, a host triggers garbage collection (GC) less frequently (e.g., avoids triggering GC), which results in improved system performance.

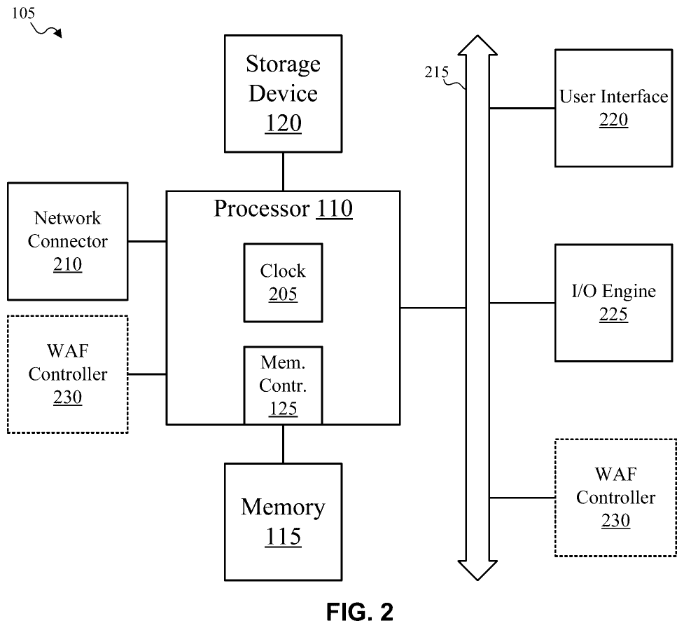

FIG. 2 illustrates details of machine 105 of FIG. 1, according to examples described herein. In the illustrated example, machine 105 may include one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220 and Input/Output (I/O) interface ports that may be managed using I/O engines 225, among other components. As shown, processors 110 may be coupled to WAF controller 230, which may be an example of WAF controller 140 of FIG. 1. Additionally, or alternatively, processors 110 may be connected to buses 215, to which may be attached WAF controller 230.

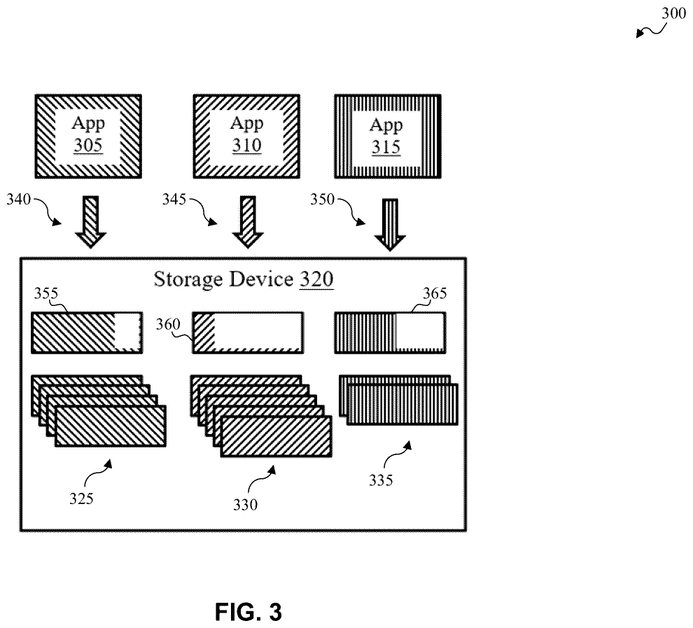

FIG. 3 illustrates an example system 300 in accordance with one or more implementations as described herein. System 300 illustrates an example embodiment of a logical view of a storage device implementing an FDP scheme in accordance with example embodiments of the disclosure. As shown, system 300 may include one or more applications (e.g., application 305, application 310, application 315). In the illustrated example, the one or more applications may be associated with at least one storage device (e.g., storage device 320). As shown, storage device 320 may include one or more Reclaim Units (e.g., RUs 325, RUs 330, RUs 335), and may be associated with one or more Reclaim Unit Handles (e.g., RUH 340, RUH 345, RUH 350). As shown, RUH 340 may point to RUs 325, RUH 345 may point to RUs 330, and RUH 350 may point to RUs 335.

In the illustrated example, RUs 325 may include RU 355, RUs 330 may include RU 360, and RUs 335 may include RU 365. At any given time, a first application may be filling an RU of a first set of RUs (e.g., application 305 filling RU 355 of RUs 325). Concurrently or at a different time, a second application may be filling an RU of a second set of RUs (e.g., application 305 filling RU 360 of RUs 330). As shown, RUH 340 may fill RU 355 with data associated with application 305. Concurrently, or at a different time, RUH 345 may fill RU 360 with data associated with application 310. Concurrently, or at a different time, RUH 350 may fill RU 365 with data associated with application 315.

As shown, RUH 340 may fill RU 355 with data based on having already filled one or more RUs associated with application 305. Similarly, RUH 345 may fill RU 360 based on having already filled one or more RUs associated with application 310, and/or RUH 350 may fill RU 365 based on having already filled one or more RUs associated with application 315. In some cases, storage device 320 may include a NAND flash-based storage drive. In some cases, storage device 320 may include flexible data placement (FDP) based on the non-volatile memory express (NVMe) specification. As shown, application 305 may write data to a first portion of storage device 320 that is allocated for application 305. Similarly, application 310 may write data to a second portion of storage device 320 that is allocated for application 310, and application 315 may write data to a third portion of storage device 320 that is allocated for application 315.

In some examples, applications of system 300 may use different RUHs to direct their respective write traffic. As shown, application 305 may use RUH 340 to direct write traffic to RUs 325; application 310 may use RUH 345 to direct write traffic to RUs 330; and/or application 315 may use RUH 350 to direct write traffic to RUs 335.

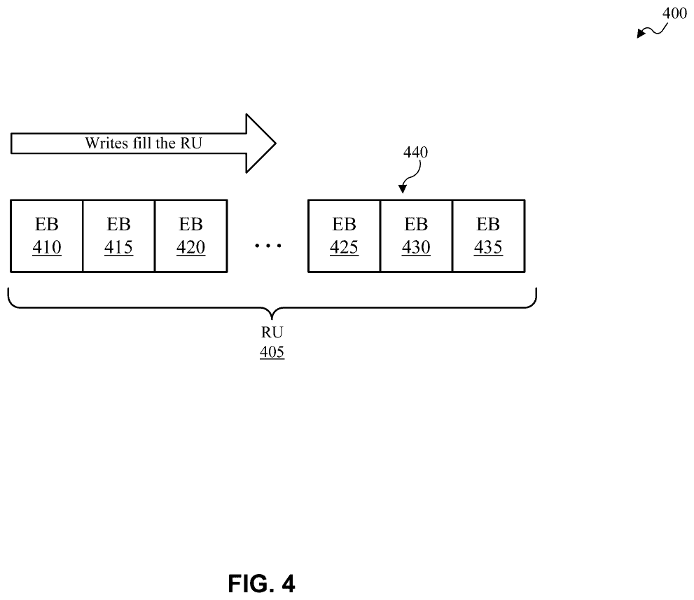

FIG. 4 illustrates an example format 400 in accordance with one or more implementations as described herein. In the illustrated example, format 400 may include a format of a reclaim unit (e.g., RU 405). A given storage drive may include one or more reclaim units such as RU 405. As shown, a format of RU 405 may be based on one or more erase blocks (e.g., EB 410, EB 415, EB 420, EB 425, EB 430, and EB 435).

In some embodiments, an RU such as RU 405 may be similar or equivalent to a SuperBlock (SB) (e.g., an SB may equal at least one EB per plane for one or more (e.g. every) die). An RU may be filled in a sequential order (even if the LBAs are out-of-order) as illustrated in format 400.

After filling an RU, an SSD (e.g., based on a command from a host) may select a new set of empty EBs to create a new RU. In some cases, a new RU may be appended (e.g., logically appended) to RU 405 when RU 405 is filled up or near being filled up. In some cases, a host may track a fill level of RU 405 to determine how full RU 405 is at any given time. To track a fill level and/or determine how full an RU is at any given time, a host may perform at least one of the following: query a storage drive's RU size, and/or send writes and sum the amount of data sent to the storage drive on each write command (e.g., sum (Number of Logical Blocks per write). Number of Logical Blocks (NLB) may refer to the number of logical blocks or the number of LBAs of a storage drive. A command sent to the drive may have a length (e.g., NLBs), which may vary from one write command to the next. The systems and methods may include determining the NLB associated with each command to track how much data is sent to the RU, enabling a host to track the fill level of an RU and/or determine how full an RU is at any given time.

Additionally, or alternatively, to track a fill level and/or determining how full an RU is at any given time, a host may perform at least one of the following: compare the amount of data sent for when the RU size is filled; when writing more data than can fit in a given RU (e.g., for a given write command), placing the spillover data into the next RU; periodically querying the Reclaim Unit Available Media Writes (RUAMW) value to confirm the host estimate matches the drive fill value of the RU. The RUAMW may include a field (e.g., of a message, of a command) that indicates the number of logical blocks that are currently available to be written to in storage media associated with a Reclaim Unit that is referenced by a Placement Identifier field. The RUAMW may be queried (e.g., by a host) to determine the amount of space remaining in a given RU (e.g., the active RU that is currently being filled). If the running total of data sent to the RU is referred to as the total data (e.g., total X), then RUAMW may be determined based on the difference of the RU nominal size and the sum of NLBs for each command (e.g., RU nominal size−sum(NLBs for each command)). The systems and methods described help fix errors associated with write commands and help avoid issues when a drive is handling a storage media issue and consumes some writes into the RU internally within the drive due to the media handling.

When a fill level of RU 405 satisfies a fill threshold, the host may instruct the storage device to add another RU. In some cases, a storage drive may automatically move to the next available RU when the last RU is filled. However, in some cases, the host may be tracking host side objects of size X, where size X is less than the RU size, but may be relatively close to the RU size, for example. The host may determine to delete the objects together. Therefore, the host may choose to send a command to the storage drive to move to a new RU for this particular RUH. This command may force the drive to move to the next RU and waste a bit of space at the end of the last RU. But based on the host object being deallocated together, this may provide a WAF=1 behavior. Overall, the small waste of space due to objects not aligning to end at the RU boundary may be acceptable because of the benefit of providing WAF=1.

In some embodiments, one or more rules may be applied in selecting EBs from a free pool of EBs (e.g., at least one EB per plane for a given die (e.g., every die) to create a SB, selecting EBs that are estimated to have a similar amount of wear on them, etc.). A drive with one RUH may operate with random traffic.

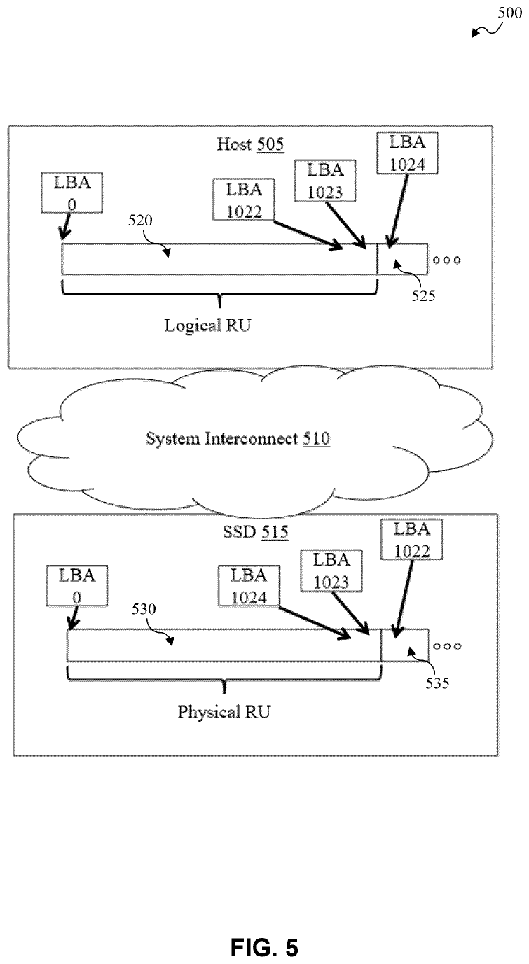

FIG. 5 illustrates an example system 500 in accordance with one or more implementations as described herein. As shown, system 500 may depict a host 505, a system interconnect 510, and an SSD 515. It is noted that reference to “SSD” or “NAND flash-based storage drive” may be used interchangeably with “storage drive” or “storage device” throughout the provided description. For example, “SSD” or “NAND flash-based storage drive” may be used as one example implementation of multiple possible implementations, where one or more examples described herein may be implemented with a storage drive of any type or with a storage device of any type (e.g., any type of flexible data placement storage devices).

As shown, host 505 may include a logical RU being tracked by host 505, where the host maps the logical RU to a physical RU being filled by SSD 515. As shown, the logical RU may include one or more logical block addresses (LBAs) (e.g., LBA 0, . . . . LBA 1022, LBA 1023, LBA 1024). As shown, the allocated logical capacity of host 505 may include at least first logical RU 520 and second logical RU 525. A logical RU may include a data structure that indicates status and/or fill state of a physical RU. In some examples, a host may track an estimate of how much data is in the RU in the drive. A logical RU may include a data structure that indicates what LBAs the logical RU determines are in a given RU (e.g., tracking based on a count). In some cases, the logical RU may track (e.g., track precisely) which LBAs are being placed within a given RU. Although an SSD may change RUs at will, a host (e.g., host 505) tracking a logical RU may be based on one or more assumptions. For example, a storage drive may determine not to move LBAs unless the storage drive identifies a use for moving the LBAs. For example, a drive may determine to move an LBA based on garbage collection, based on surprise media handling, and the like. Based on the systems and methods described, WAF may be controlled to be a WAF of 1 (e.g., WAF=1), in which case a host can eliminate moving an LBA based on garbage collection. It is noted that moving an LBA based on surprise media handling is unlikely. In cases where the occurrence of moving an LBA based on surprise media handling is more than likely, then a host may be configured to query the storage drive's statistics log (e.g., FDP statistics log) and/or query the storage drive's events log (e.g., FDP events log) for controller events.

As shown, SSD 515 may include a physical RU that is mapped to the logical RU of host 505. As shown, the physical RU may be tracked by host 505 and may be associated with the one or more logical block addresses (LBAs) (e.g., LBA 0, . . . . LBA 1022, LBA 1023, LBA 1024). As shown, the allocated physical capacity of SSD 515 may include at least first physical RU 530 and second physical RU 535, where host 505 maps first logical RU 520 to first physical RU 530 and map second logical RU 525 to second physical RU 535.

In some embodiments, system race conditions and/or delays (e.g., command delays) may occur in relation to host 505 and/or SSD 515. For example, for queue depth (QD) greater than 1 (e.g., QD>1, for a relatively high QD) out-of-order processing may occur. The out-of-order processing can create a disconnect between the tracking of the logical RU by host 505 and the filling of the physical RU of SSD 515. In some cases, the race conditions and/or delays may result in orphan LBAs. Based on the illustrated example, host 505 may construct individual commands to every LBA 0 to LBA 2047, and sequentially send each of these commands to the SSD at a similar time (e.g., concurrently) such that a large QD accumulates, where one or more of these write commands may be in flight concurrently. The host 505 may then expect LBA 0 to LBA 1023 to be in first logical RU 520, and then LBA 1024 to LBA 2047 to be in second logical RU 525, as shown with the logical RU of host 505. However, based on the race conditions and/or delays, LBA 0 to LBA 1021, LBA 1023, and LBA 1024 may be actually end up in first physical RU 530 in SSD 515, while LBA 1022 may end up in second physical RU 535.

For one or more (e.g., each) LBA in range [0, 10000] (e.g., write LBA), SSD 515 may deallocate a logical RU of LBA range [0 to 1023]. However, as shown, LBA 1024 may be in first physical RU 530, while the host is tracking LBA 1024 to be in second logical RU 525. Thus, LBA 1024 may end up being the only LBA that is valid in first physical RU 530. Also, LBA 1022 may be deallocated where the rest of the second RU remains valid and LBA 1022 is invalid.

The systems and methods may mitigate the effects of the system race conditions and/or delays by configuring host 505 with a QD=1 (e.g., through all host operations). With the host running on QD=1, the host may send (e.g., per RUH) a first command and wait for a first response. The host may then send (e.g., per RUH) a second command after receiving the first response and wait for a second response, and so on. Additionally, or alternatively, the systems and methods may wait for one or more (e.g., all) completions of a given Logical RU (e.g., the logical RU of host 505) to return before starting any write operations on a new RU (e.g., second logical RU 525).

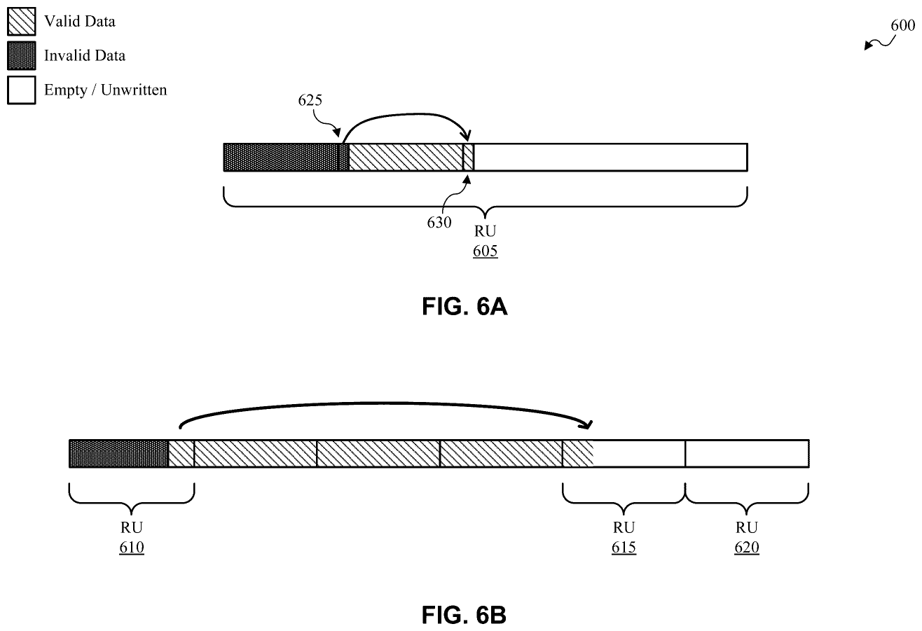

FIG. 6A and FIG. 6B illustrate aspects of example data structures (e.g., data structures 600) in accordance with one or more implementations as described herein. FIG. 6A may depict a circular buffer configured with few enough LBAs to fit within an RU. FIG. 6B may depict a circular buffer that spans more than one RU. In some cases, a host may implement a circular buffer on the host side, which may be different from a write buffer on the storage drive side. In some examples, a host may log events (e.g., the last 1,000 events). Accordinglyh, the host may write the last 1,000 events in a circular buffer. In some cases, the circular buffer may be configured as a circular FIFO. Based on the host logging this data in a circular buffer, WAF may remain at 1 in the storage drive.

In the illustrated example, data structures 600 depict one or more RUs (e.g., RU 605, RU 610, RU 615, RU 620). As shown, RU 605 includes invalid data, valid data, and empty portions (e.g., deallocated portions of storage). It is noted that RU 605 may store data as the data comes in. However, RU 605 may continue to store older data even after the older data gets invalidated. In some cases, the new data may come in and may be placed on the end at the current append point. In the illustrated example, RU 610 includes invalid data and valid data, a portion of RU 615 includes valid data being written to RU 615, and RU 620 includes empty or unwritten portions of storage. When RU 615 is filled, then data may be written to RU 620.

Some example embodiments of WAF==1 workloads may be based on Circular FIFO; Modified Circular Buffer; Log Structured File Systems; Probabilistic implementations; and/or Log Structured File Systems with Mismatched Host Extent and SSD RU. An example embodiment of a circular FIFO may be implemented as illustrated in FIG. 6A and FIG. 6B.

In some cases, a circular FIFO may be configured to loop over any LBA range. For example, a circular FIFO may be based on an LBA Range that is constant, based on deallocated storage space with invalid data and writing to the deallocated space, and/or a direct overwrite of an LBA. As shown, RU 605 may include a segment of invalid data, valid data, and empty data. As a portion of data becomes invalid, a portion of data may be written to a next portion of RU 605 in a sequential, circular FIFO manner. For example, RU 605 includes invalid data 625. In some cases, invalid data 625 may be associated with an LBA (e.g., LBA 0). In the illustrated example, LBA 0 may be written a second time to RU 605. Because LBA 0 is written a second time (e.g., valid data 630), the original data (e.g., invalid data 625) may remain in the storage medium (e.g., NAND). As new data for LBA 0 is received, the new data is written as valid data 630. In some cases, RU 605 may be configured as a circular buffer. Accordingly, the next LBA after valid data 630 would be LBA 1, and so on. Once the max LBA is reached in the circular buffer, then the next LBA may return to LBA 0.

In some embodiments, any length of an RU may be used for RU 605. A new empty RU may be appended as an RU approaches being filled. In the illustrated example, the data structure of FIG. 6A may be configured as a circular buffer where the circular buffer size is less than an RU size of (e.g., RU 605). Additionally, or alternatively, the data structure of FIG. 6B may be configured as a circular buffer where the circular buffer size is greater than the RU size (e.g., size of RU 610, RU 615, RU 620). As shown, RU 615 is being filled with data. As RU 615 reaches a state of being filled (e.g., satisfies a fill threshold), RU 620 may be added. New data may be written to RU 615 until RU 615 is filled. Once filled, new data may be written to RU 620. In some cases, as new data is written, old data may be made invalid. In some cases, the invalid data may left as invalid in a given RU, while a new RU is filled and/or a new RU is added.

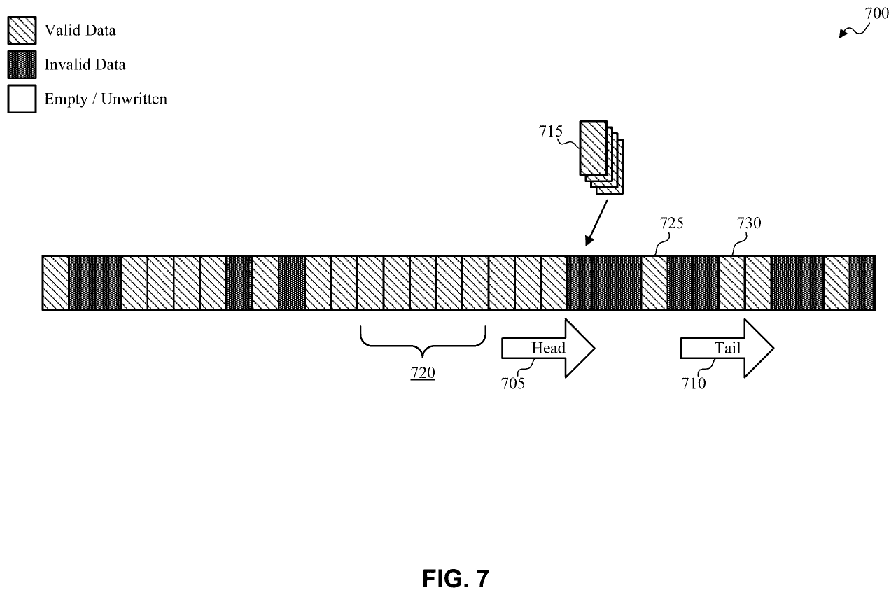

FIG. 7 illustrates an example circular buffer 700 in accordance with one or more implementations as described herein. Circular buffer 700 (e.g., a modified circular buffer) may include segments of data that include valid data, invalid data, and/or empty or unwritten storage space. As shown, circular buffer 700 may include head 705 and tail 710.

In the illustrated example, the valid data of circular buffer 700 may include valid data 725 and valid data 730 (e.g., stored data that remains valid). In some cases, valid data 725 and/or valid data 730 may be read out to another storage location (e.g., for data compaction purposes). In some cases, after reading out valid data 725 and/or valid data 730 to another storage location, the associated storage device may deallocate the depicted storage locations of valid data 725 and/or valid data 730. Invalid data may be deallocated by the storage device (e.g., based on a process of the storage device and/or a command from the host). The valid data may include recently written data 720 that remains valid data.

In some embodiments, race conditions and/or command processing delays may alter RU association (e.g., RU boundaries) based on a host being configured with QD>1. Some storage drive architectures may be exposed to different delays, for example, when the storage drive deallocates then writes LBAs and/or direct overwrite LBAs. To avoid or minimize these delays, some embodiments may include SSD overprovisioning (OP) and Host OP. Providing some SSD OP may reduce the probability the emptying RU will be used for the newest RU. For host OP, deallocations relatively far ahead of the LBA's overwrite may enable the most consistent cross-vendor behaviors. For example, some amount of data (e.g., at least one RU size worth of data) may be deallocated prior to writing to the storage device.

In some examples, WAF==1 may be achieved based on deallocate assurances. For example, in a cache management implementation, head 705 may be where incoming cache entries are appended to circular buffer 700. In some cases, tail 710 may be where still valid cache entries are read out, which the associated drive may transition to invalid. In some embodiments, one or more invalid cache entries may be deallocated to the drive or left in place.

In some embodiments, objects may be appended to fill an RU. Host garbage collection (GC0 may be aligned with SSD GC activity. For example, deallocations may be implemented as part of achieving WAF==1. In some examples, an RU (e.g., a full RU) deallocation may be aligned with the file system. In some cases, invalid objects may be communicated to an SSD by sending the drive a deallocation for the range of LBAs used by the object. In some implementations, object-to-RU endings may be misaligned when QD>1 and/or object deallocations may not be communicated to the SSD.

Some embodiments may include both an SSD physical OP allocation and a Host logical OP allocation (e.g., mapped to the physical OP allocation). In some embodiments, SSD OP may enable robust operation, for example, without object deallocations being communicated to the SSD. In some cases, the Host OP and SSD OP may compensate for race-conditions and/or command delays on Object-to-RU placement, minimizing or avoiding orphan LBAs, etc. Measurements and/or modeling of WAF behavior may result in WAF==1 conditionally, for example, N*(Host Extents)=SSD RU, where N=1, 2, . . . , and/or results may be dependent upon host OP.

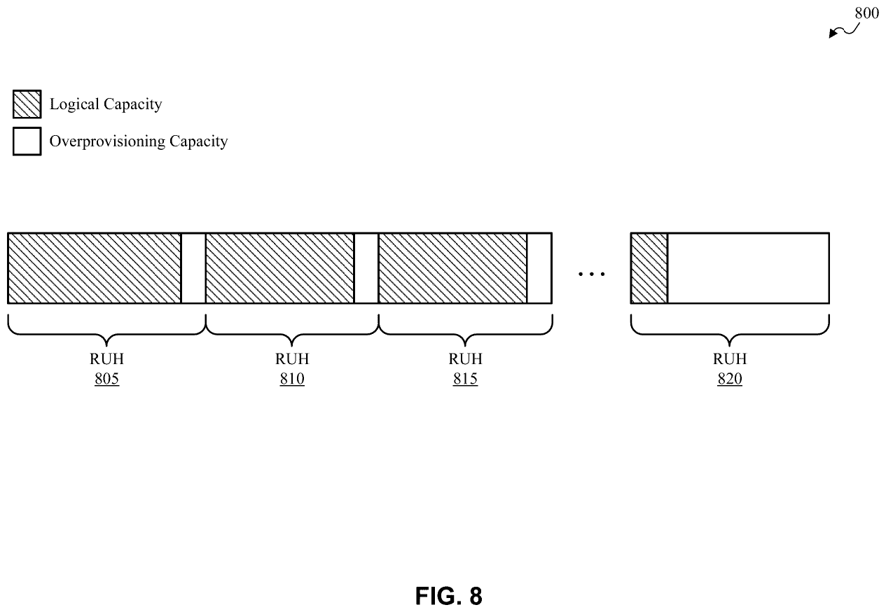

FIG. 8 illustrates an example storage configuration 800 in accordance with one or more implementations as described herein. In the illustrated example, storage configuration 800 may include one or more RUH allocations (e.g., RUH 805, RUH 810, RUH 815, to RUH 820). As shown, a given RUH allocation may include a logical capacity and an overprovisioning (OP) capacity. In some cases, an OP capacity may be based on a default OP capacity. In some cases, an RUH may not utilize an OP capacity for all operations. For example, when a host and/or SSD determines to add an RU to an RUH (e.g., add RU to RUH 815), then the host and/or SSD may allocate a portion of OP to an associated RUH (e.g., allocate a portion of OP to RUH 815).

Storage configuration 800 may depict an example embodiment of transitioning an RUH from sequential writes operations to random write operations. In some cases, an RUH (e.g., a depicted RUH of storage configuration 800) may be or include a new append point in a given storage device. In some cases, a host may use characterization of write behavior per RUH to understand a drive's WAF. For example, for a storage device with WAF==1, there may be WAF==1 on one or more (e.g., each) RUH of the storage device. However, WAF improvements on at least one RUH may benefit a larger portion of (e.g., an entire portion) of a storage drive.

In some examples, a relatively low WAF can be achieved based on probabilities. For example, a relatively high OP may correlate to a relatively low WAF. In some cases, a relatively low WAF may be achieved based on one or more RUHs allowing another RUH to consume a relatively high portion of OP (e.g., all OP allocated to a drive). For example, one or more RUHs associated with sequential write operations may allow an RUH associated with random write operations to consume a relatively high portion of OP.

Based on the systems and methods described, RUH 820 may be allocated a relatively small logical capacity while maintaining a relatively large physical capacity in RUH 820. In some cases, a host may obtain access to a storage device with a preconfigured physical storage capacity, a preconfigured logical storage capacity mapped to the physical storage capacity, and a preconfigured overprovisioning capacity based on a ratio or percentage of the physical storage capacity (e.g., 5%, 7%, 10%, or 12% physical storage capacity, etc.). In some cases, a host may assign a first portion of the logical storage capacity to RUH 815 and a second portion of the logical storage capacity to RUH 820. The host may select RUH 820 to manage random write operations based on identifying random write operations on the storage device. In some cases, the host may determine that RUH 820 is performing random write operations and assign the write operations to RUH 820 accordingly. Based on the selection of RUH 820, the host may reduce the logical storage capacity of RUH 820, while the physical storage capacity of RUH 820 is maintained (e.g., or increased). For example, RUH 820 may be configured with a logical storage capacity that is similar to the depicted logical storage capacity of RUH 805, RUH 810, or RUH 815 (e.g., a logical storage capacity that is relatively large compared to an overprovisioning capacity). The logical storage capacity of RUH 805, RUH 810, and/or RUH 815 may be a multiple (e.g., 2×, 3×, 5×, 10×, 15×, 20×, etc.) of an overprovisioning capacity of RUH 805, RUH 810, and/or RUH 815. In some cases, an initial logical storage capacity of RUH 820 may be a multiple of an overprovisioning capacity of RUH 820. However, based on the identification of random write operations, the host may reduce (e.g., shrink) the logical storage capacity of RUH 820 as shown. Based on the selection of RUH 820 for random write operations, the host may assign to RUH 820 at least some portion of an available amount (e.g., a maximum available amount) of the overprovisioning capacity (e.g., a majority of the overprovisioning capacity assigned to the underlying storage device, at least half of the overprovisioning capacity assigned to the underlying storage device, all or nearly all the overprovisioning capacity assigned to the underlying storage device). Additionally, or alternatively, based on the SSD recognizing the lower WAF behavior (e.g., WAF=1 behavior) of RUHs 805, 810, and/or 815, the SSD may allocate more OP to RUH 820.

In some cases, the systems and methods may be based on log structured file systems with mismatched host extent and SSD physical RU. For example, the size of a physical RU of an SSD may be relatively small compared to the size of a logical storage capacity of a host (e.g., host extent, logical host RU size). In some embodiments, a log structured file system may be built with host extents, for example, rather than the physical size of an RU matching the logical size. In such embodiments, the drive behavior may be a mixture of various behaviors. In some examples, a host extent that does not match a physical RU may be implemented because of vendor mismatch, generational RU changes, software developed separately from SSDs, etc. In some embodiments, large host extents (e.g., large logical RU sizes) relative to physical RU sizes may improve WAF.

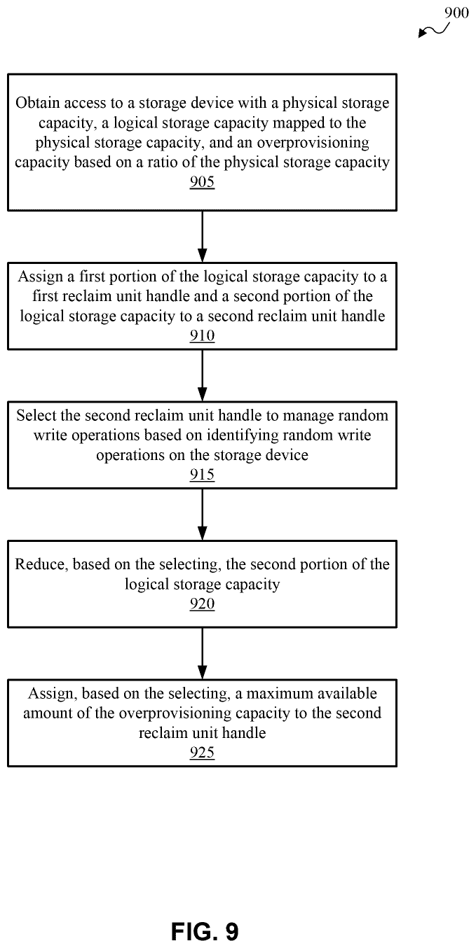

FIG. 9 depicts a flow diagram illustrating an example method 900 associated with the disclosed systems, in accordance with example implementations described herein. In some configurations, method 900 may be implemented by WAF controller 140 of FIG. 1 and/or WAF controller 230 of FIG. 2. In some configurations, method 900 may be implemented in conjunction with machine 105, components of machine 105, or any combination thereof. The depicted method 900 is just one implementation and one or more operations of method 900 may be rearranged, reordered, omitted, and/or otherwise modified such that other implementations are possible and contemplated.

At 905, method 900 may include obtaining access to a storage device with a physical storage capacity, a logical storage capacity mapped to the physical storage capacity, and an overprovisioning capacity based on a ratio of the physical storage capacity. For example, host 505 may obtain access to a storage device (e.g., SSD 515) with a preconfigured physical storage capacity, a preconfigured logical storage capacity mapped to the physical storage capacity, and a preconfigured overprovisioning capacity based on a ratio of the physical storage capacity.

At 910, method 900 may include assigning a first portion of the logical storage capacity to a first reclaim unit handle and a second portion of the logical storage capacity to a second reclaim unit handle. For example, host 505 may assign a first portion of the logical storage capacity to RUH 805 and a second portion of the logical storage capacity to RUH 820.

At 915, method 900 may include selecting the second reclaim unit handle to manage random write operations based on identifying the random write operations on the storage device. For example, host 505 may select the second reclaim unit handle to manage random write operations based on identifying the random write operations on the storage device.

At 920, method 900 may include reducing, based on the selecting, the second portion of the logical storage capacity. For example, host 505 may reduce, based on the selecting, the second portion of the logical storage capacity of RUH 820.

At 925, method 900 may include assigning, based on the selecting, an available amount of the overprovisioning capacity to the second reclaim unit handle. For example, host 505 may assign, based on the selecting, a maximum available amount of the overprovisioning capacity to the second reclaim unit handle. In some cases, the host may assign less than a maximum available amount of the overprovisioning capacity or a percentage of the overprovisioning capacity (e.g. 90%, 70% 50% of available amount of the overprovisioning capacity, etc.). For example, a first amount of the overprovisioning capacity (e.g., a default amount) may be assigned to the first reclaim unit handle. Additionally, or alternatively, some amount of the overprovisioning capacity may be assigned to one or more other reclaim unit handles, leaving an available amount of the overprovisioning capacity. Accordingly, the host may assign at least some portion of the available amount of the overprovisioning capacity to the second reclaim unit handle.

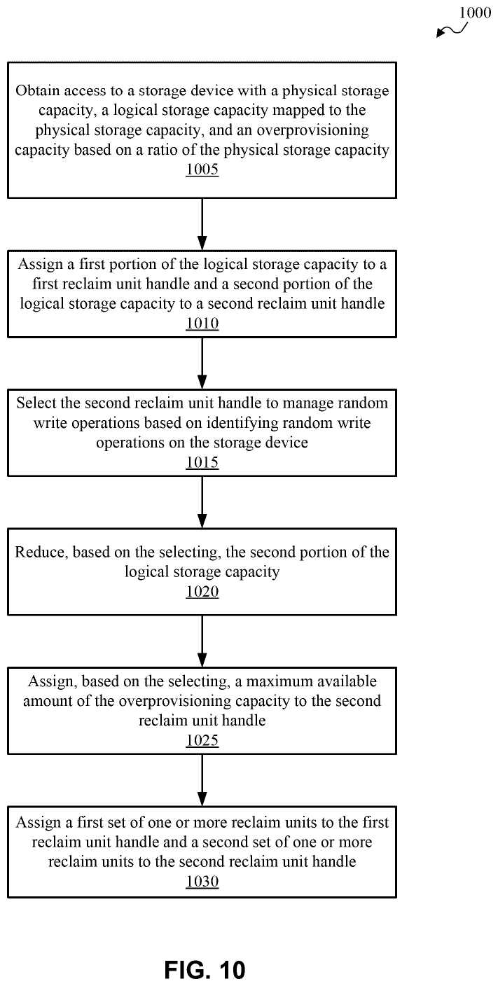

FIG. 10 depicts a flow diagram illustrating an example method 1000 associated with the disclosed systems, in accordance with example implementations described herein. In some configurations, method 1000 may be implemented by WAF controller 140 of FIG. 1 and/or WAF controller 230 of FIG. 2. In some configurations, method 1000 may be implemented in conjunction with machine 105, components of machine 105, or any combination thereof. The depicted method 1000 is just one implementation and one or more operations of method 1000 may be rearranged, reordered, omitted, and/or otherwise modified such that other implementations are possible and contemplated.

At 1005, method 1000 may include obtaining access to a storage device with a physical storage capacity, a logical storage capacity mapped to the physical storage capacity, and an overprovisioning capacity based on a ratio of the physical storage capacity. For example, host 505 may obtain access to a storage device (e.g., SSD 515) with a preconfigured physical storage capacity, a preconfigured logical storage capacity mapped to the physical storage capacity, and a preconfigured overprovisioning capacity based on a ratio of the physical storage capacity.

At 1010, method 1000 may include assigning a first portion of the logical storage capacity to a first reclaim unit handle and a second portion of the logical storage capacity to a second reclaim unit handle. For example, host 505 may assign a first portion of the logical storage capacity to RUH 805 and a second portion of the logical storage capacity to RUH 820.

At 1015, method 1000 may include selecting the second reclaim unit handle to manage random write operations based on identifying the random write operations on the storage device. For example, host 505 may select the second reclaim unit handle to manage random write operations based on identifying the random write operations on the storage device.

At 1020, method 1000 may include reducing, based on the selecting, the second portion of the logical storage capacity. For example, host 505 may reduce, based on the selecting, the second portion of the logical storage capacity of RUH 820.

At 1025, method 1000 may include assigning, based on the selecting, an available amount of the overprovisioning capacity to the second reclaim unit handle. For example, host 505 may assign, based on the selecting, a maximum available amount of the overprovisioning capacity to the second reclaim unit handle. In some cases, the host may assign less than a maximum available amount of the overprovisioning capacity or a percentage of the overprovisioning capacity (e.g. 90%, 70% 50% of available amount of the overprovisioning capacity, etc.). For example, a first amount of the overprovisioning capacity (e.g., a default amount) may be assigned to the first reclaim unit handle. Additionally, or alternatively, some amount of the overprovisioning capacity may be assigned to one or more other reclaim unit handles, leaving an available amount of the overprovisioning capacity. Accordingly, the host may assign at least some portion of the available amount of the overprovisioning capacity to the second reclaim unit handle.

At 1030, method 1000 may include assigning a first set of one or more reclaim units to the first reclaim unit handle and a second set of one or more reclaim units to the second reclaim unit handle. For example, host 505 may assign a first set of one or more reclaim units to RUH 805 and/or assign a second set of one or more reclaim units to RUH 820. For example, when a fill level of an RU of RUH 805 satisfies a fill threshold, host 505 may instruct the storage device to add another RU to RUH 805. Additionally, or alternatively, when a fill level of an RU of RUH 820 satisfies a fill threshold, host 505 may instruct the storage device to add another RU to RUH 820. In some cases, assigning one or more RUs to an RUH may remove the one or more RUs from other available pools that other RUHs may use or may be using.

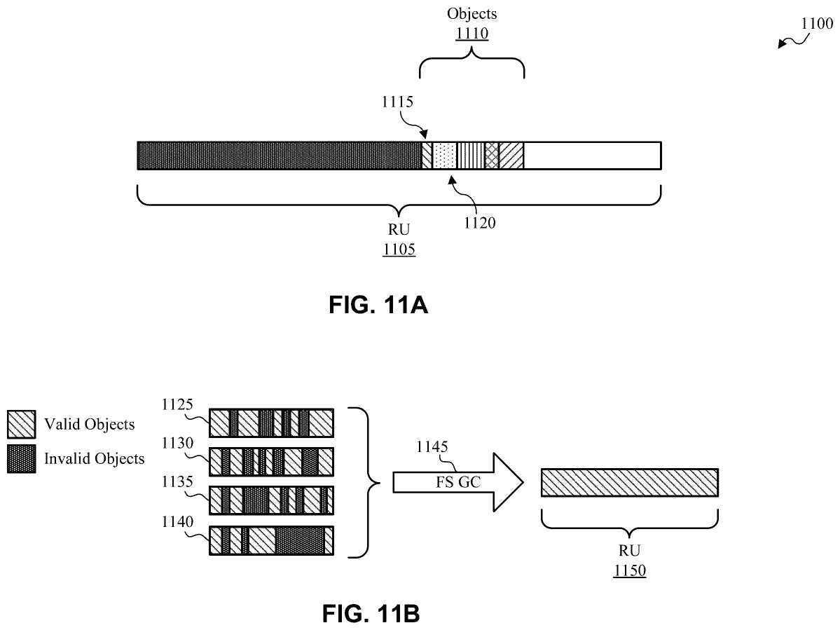

FIG. 11A and FIG. 11B illustrate aspects of example data structures (e.g., data structures 600) in accordance with one or more implementations as described herein.

FIG. 11A depicts aspects of Log Structured File Systems in relation to an RU (e.g., RU 1105). In the illustrated example, objects (e.g., object data) may be appended to fill an RU (e.g., objects 1110 appended to RU 1105). As shown, objects 1110 may include object 1115, object 1120, and so on. When a host determines or is aware of the size of an RU (e.g., RU 1105) and the host determines or is aware when the RU is full, then based on the file system, the host can determine (e.g., at the file system level) that one object was rewritten (e.g., object 1115), another object was modified (e.g., object 1120), another object has one or more overwrites, etc. Based on the aspects of Log Structured File Systems, host garbage collection may be aligned with storage drive garbage collection activity. Based on the aspects of Log Structured File Systems, full RU deallocations may be aligned with the file system.

FIG. 11B may depict a host view of one or more RUs (e.g., RU 1125, RU 1130, RU 1135, RU 1140) that may include valid data and invalid data. In the illustrated example, the depicted RUs may include valid objects and invalid objects. In some cases, a given host may identify (e.g., track) the valid objects and the invalid objects and may determine the RU boundaries (e.g., RU sizes) of RU 1125, RU 1130, RU 1135, RU 1140, etc. Accordingly, the host may read out the valid objects from RU 1125, read out the valid objects from RU 1130, read out the valid objects from RU 1135, and read out the valid objects from RU 1140, etc. In some cases, the host may read out the valid objects based on a host-driven garbage collection procedure (e.g., file system garbage collection 1145). As shown, the host may read out the valid objects from RU 1125, RU 1130, RU 1135, RU 1140 and write the valid objects to RU 1150 (e.g., to a new RU). In some cases, the host may delete or deallocate the objects of RU 1125, RU 1130, RU 1135, RU 1140 after writing the valid objects to RU 1150. Accordingly, no garbage collection occurs on the storage drive of RU 1125, RU 1130, RU 1135, and RU 1140 because the garbage collection is performed by the host. Accordingly, the storage drive of RU 1125, RU 1130, RU 1135, RU 1140, etc., achieves a WAF of 1.

In some examples, some storage devices (e.g., FDP SSDs) may accept misalignment, but may not achieve WAF=1. The systems and methods may achieve WAF=1 based on satisfying at least two constraints: (1) sum (NLBs for each command)==RU size; and (2) deallocate a given RU all together (e.g., concurrently). In some cases, the systems and methods may include tracking different objects and/or command sizes (e.g., objects 1110, command size, objects of FIG. 11B) that are filling up a given RU (e.g., RU 1105, RUs of FIG. 11B). The systems and methods may include tracking different objects and/or command sizes for multiple RUs. In some cases, a host may determine the objects that are in each RU (e.g., in RU 1105).

In some examples, one or more objects may be re-written to different LBAs of a given RU and/or to other RUs of the same drive. In some cases, some of the objects may be invalid, deallocated, and/or deleted (e.g., objects of FIG. 11B). As shown, the RUs of FIG. 11B may include invalid objects and/or overwritten portions. In some cases, the host file system may perform garbage collection based on the tracking of objects in the RUs of FIG. 11B. The host may read the valid portions into a new RU (e.g., RU 1150). In some cases, the host may perform FS GC on several RUs concurrently. In some cases, the FS may send a deallocate to each RU (e.g., to deallocate it completely). Accordingly, the two constraints (e.g., sum (NLBs for each command)==RU size, and deallocate the RU all together) may be achieved. In some cases, a host may track when an object (e.g., or one command) falls on a border or boundary of an RU, which has the head in one RU and the tail in another RU. In some cases, the host may track boundary objects and/or boundary write commands to determine what data is valid and what data is invalid.

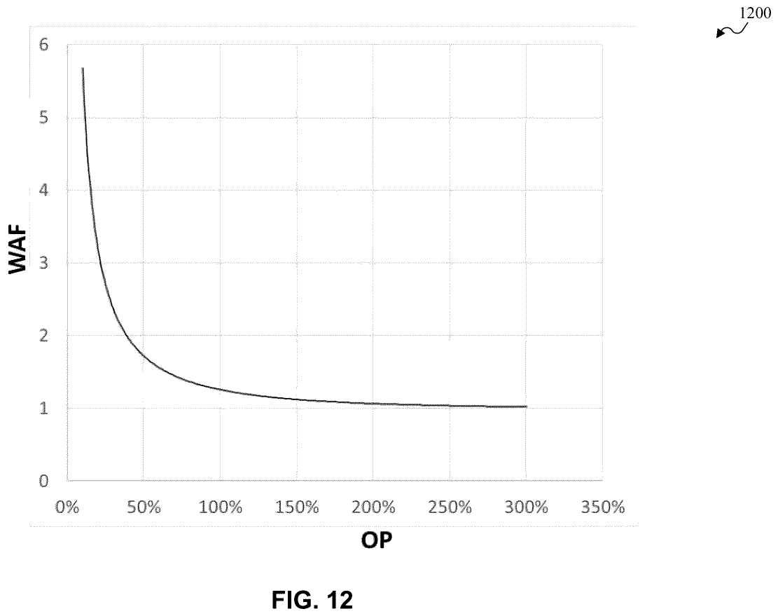

FIG. 12 illustrates an example graph 1200 in accordance with one or more implementations as described herein. As shown, graph 1200 depicts the relationship between WAF and OP. In some cases, a low WAF can be achieved through probabilities. As shown, a relatively high OP correlates to relatively low WAF. Graph 1200 may depict a model of an idealized system relationship with random write behavior as it relates to drive OP (e.g., OP of a storage device).

In some examples, drive OP may be based on an exposed logical capacity available for the host to write and store data. Drive OP may be based on the sum of the LBA storage space per namespace (e.g., for all namespaces on the drive). In some cases, a host may determine to not write data to all of the LBAs and namespaces exposed to it. In some cases, a host may choose to deallocate some LBAs from the drive. In some cases, drive OP and host OP together may be referred to as system OP. In some cases, graph 1200 may indicate that system OP (e.g., drive OP and/or host OP) may be effective (e.g., drive OP and host OP may be equally effective) at reducing WAF. As shown, based on sufficiently large OP values, WAF trends towards 1.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of storage management by a host, the method comprising:
obtaining access to a storage device with a physical storage capacity, a logical storage capacity mapped to the physical storage capacity, and an overprovisioning capacity based on a ratio of the physical storage capacity;
assigning a first portion of the logical storage capacity to a first reclaim unit handle and a second portion of the logical storage capacity to a second reclaim unit handle;
selecting the second reclaim unit handle to manage random write operations based on identifying the random write operations on the storage device;
reducing, based on the selecting, the second portion of the logical storage capacity; and
assigning, based on the selecting, an amount of the overprovisioning capacity to the second reclaim unit handle.

2. The method of claim 1, further comprising:
assigning a first set of one or more reclaim units to the first reclaim unit handle, and
assigning a second set of one or more reclaim units to the second reclaim unit handle.

3. The method of claim 2, further comprising:
adding a reclaim unit to the first set of one or more reclaim units based on determining the first set of one or more reclaim units satisfy a fill threshold; and
assigning a first portion of the overprovisioning capacity to the first reclaim unit handle based on adding the reclaim unit to the first set of one or more reclaim units.

4. The method of claim 2, wherein a reclaim unit of the first set of one or more reclaim units or the second set of one or more reclaim units comprises a group of erase blocks of the storage device.

5. The method of claim 2, further comprising:
determining the first reclaim unit handle writes data sequentially; and
verifying, based on the determining, that write commands associated with a first reclaim unit of the first set of one or more reclaim units are completed prior to initiating a write command to a second reclaim unit of the first set of one or more reclaim units.

6. The method of claim 1, further comprising configuring a queue depth of the host to be equal to one.

7. The method of claim 1, wherein the amount of the overprovisioning capacity is greater than the second portion of the logical storage capacity, the amount of the overprovisioning capacity including at least a majority of the overprovisioning capacity.

8. The method of claim 1, wherein data associated with at least one of the first reclaim unit handle or the second reclaim unit handle is written in a circular first in first out configuration.

9. The method of claim 1, wherein selecting the second reclaim unit handle to manage the random write operations includes routing the random write operations to the second reclaim unit handle.

10. The method of claim 1, wherein the storage device comprises a solid-state drive configured for flexible data placement based on a non-volatile memory express protocol.

11. A device comprising:
one or more processors; and
memory storing instructions that, when executed by the one or more processors, cause the device to:
obtain access to a storage device with a physical storage capacity, a logical storage capacity mapped to the physical storage capacity, and an overprovisioning capacity based on a ratio of the physical storage capacity;
assign a first portion of the logical storage capacity to a first reclaim unit handle and a second portion of the logical storage capacity to a second reclaim unit handle;
select the second reclaim unit handle to manage random write operations based on identifying the random write operations on the storage device;
reduce, based on the selecting, the second portion of the logical storage capacity; and
assign, based on the selecting, an amount of the overprovisioning capacity to the second reclaim unit handle.

12. The device of claim 11, wherein the instructions, when executed by the one or more processors, further cause the device to:
assign a first set of one or more reclaim units to the first reclaim unit handle, and
assign a second set of one or more reclaim units to the second reclaim unit handle.

13. The device of claim 12, wherein the instructions, when executed by the one or more processors, further cause the device to:
add a reclaim unit to the first set of one or more reclaim units based on determining the first set of one or more reclaim units satisfy a fill threshold; and
assign a first portion of the overprovisioning capacity to the first reclaim unit handle based on adding the reclaim unit to the first set of one or more reclaim units.

14. The device of claim 12, wherein a reclaim unit of the first set of one or more reclaim units or the second set of one or more reclaim units comprises a group of erase blocks of the storage device.

15. The device of claim 12, wherein the instructions, when executed by the one or more processors, further cause the device to:
determine the first reclaim unit handle writes data sequentially; and
verify, based on the determining, that write commands associated with a first reclaim unit of the first set of one or more reclaim units are completed prior to initiating a write command to a second reclaim unit of the first set of one or more reclaim units.

16. The device of claim 11, wherein the instructions, when executed by the one or more processors, further cause the device to configure a queue depth of the device to be equal to one.

17. The device of claim 11, wherein the amount of the overprovisioning capacity is greater than the second portion of the logical storage capacity, the amount of the overprovisioning capacity including at least a majority of the overprovisioning capacity.

18. A non-transitory computer-readable medium storing code that comprises instructions executable by a processor to:
obtain access to a storage device with a physical storage capacity, a logical storage capacity mapped to the physical storage capacity, and an overprovisioning capacity based on a ratio of the physical storage capacity;
assign a first portion of the logical storage capacity to a first reclaim unit handle and a second portion of the logical storage capacity to a second reclaim unit handle;
select the second reclaim unit handle to manage random write operations based on identifying the random write operations on the storage device;
reduce, based on the selecting, the second portion of the logical storage capacity; and
assign, based on the selecting, an amount of the overprovisioning capacity to the second reclaim unit handle.

19. The non-transitory computer-readable medium of claim 18, wherein the code includes further instructions executable by the processor to:
assign a first set of one or more reclaim units to the first reclaim unit handle, and
assign a second set of one or more reclaim units to the second reclaim unit handle.

20. The non-transitory computer-readable medium of claim 19, wherein the code includes further instructions executable by the processor to:
add a reclaim unit to the first set of one or more reclaim units based on determining the first set of one or more reclaim units satisfy a fill threshold; and
assign a first portion of the overprovisioning capacity to the first reclaim unit handle based on adding the reclaim unit to the first set of one or more reclaim units.
